(19) United States
(12) Patent Application Publication
(10) Pub. No.: US 2010/0264113 A1
(43) Pub. Date: Oct. 21, 2010

(54) TEMPLATE, METHOD OF MANUFACTURING THE SAME, AND METHOD OF FORMING PATTERN

(76) Inventors: Ikuo YONEDA, Yokohama-Shi (JP); Takuya Kono, Yokosuka-Shi (JP); Tetsuro Nakasugi, Yokohama-Shi (JP); Ryoichi Inanami, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/724,819

(22) Filed: Mar. 16, 2010

(30) Foreign Application Priority Data
Apr. 17, 2009 (JP) 2009-100937

(51) Int. Cl. B44C 1/22; B29C 35/08; B29C 59/02

(52) U.S. Cl. 216/41; 264/494; 425/385

(57) ABSTRACT

There is provided a template in which a gap region of a substrate to be processed can be covered with an imprint resist, a method of manufacturing the same, and a method of forming a pattern.

A template used in an optical imprint method includes a substrate, a pattern forming region that is provided on the substrate and includes an imprint pattern, a first step portion that is provided outside the pattern forming region and is disposed below the pattern forming region, a first side portion that connects the pattern forming region and the first step portion, a second step portion that is provided outside the first step portion and is disposed below the first step portion, and a second side portion that connects the first step portion and the second step portion and has a surface roughness more than that of the first side portion.

### CROSS-REFERENCE TO RELATED APPLICATION

This application is based upon and claims the benefit of priority from prior Japanese Patent Application No. 2009-100937, filed on Apr. 17, 2009, the entire contents of which are incorporated herein by reference.

### BACKGROUND OF THE INVENTION

1. Field of the Invention

The present invention relates to an imprint template, a method of manufacturing the same, and a method of forming a pattern using the template.

2. Background Art

In a process of manufacturing semiconductor devices, an imprint lithography technique has drawn attention as a technique capable of improving both the workability and the mass productivity of fine patterns with a width of 100 nm or less. In the imprint lithography technique, a patterned template (which is also called a mold or a stamper) is contacted with a resist applied onto a substrate to be processed, such as a wafer, thereby transferring the pattern.

That is, the imprint lithography technique contacts a template, which is a mold having a predetermined pattern to be transferred formed on one surface thereof, with an organic material applied onto the substrate to be processed, and cures the imprint resist, thereby transferring the pattern. Hereinafter, an imprint resist will be referred to an organic material applied onto the substrate to be processed.

As the imprint lithography method, for example, the following methods have been known: a thermal imprint method (for example, U.S. Pat. No. 5,772,905 and Japanese Patent Application Laid-Open (JP-A) No. 2003-77807) using a thermoplastic resist as the imprint resist; an optical imprint method (for example, JP-A Nos. 2001-68411 and 2000-194142) using a photo-curable resist as the imprint resist. Among them, the flow of a process of transferring a pattern using the optical imprint method will be described briefly.

The optical imprint method includes the following processes.

(1) A photo-curable resist is applied onto a substrate to be processed (application process).

(2) The substrate to be processed and a template are aligned with each other (alignment process).

(3) The template comes into contact with the photo-curable resist (pressing process).

(4) UV light is radiated to cure the photo-curable resist (transfer process).

(5) The template is separated from the cured photo-curable resist (demolding process).

One shot means that the template is pressed against the imprint resist applied onto the substrate to be processed once. A resist pattern formed by one shot is obtained by the above-mentioned processes. Hereinafter, an imprint resist pattern will be referred to a resist pattern formed by one shot. The processes are stepped and repeated to regularly form imprint resist patterns on the substrate to be processed. Then, a remaining film removing process of removing the remaining photo-curable resist film is performed, and etching is performed on the substrate to be processed using the imprint resist patterns as a mask.

The above-mentioned optical imprint method is called an SFIL (Step and Flash Imprint Lithography) method and has drawn attention as a method of forming a fine pattern in the semiconductor device. In the SFIL method, the imprint resist is applied onto the substrate to be processed for each shot.

For example, a spin coating method and an ink jet method are used to apply the imprint resist. The ink jet method applies liquid droplets of the imprint resist to a substrate to be processed. In this case, the application amount of liquid droplets is controlled in consideration of the density of a pattern to be imprinted such that the imprint resist is widely spread into a predetermined pattern formed on one surface of the template facing the substrate to be processed. Hereinafter, an imprint pattern will be referred to a predetermined pattern formed on one surface of the template facing the substrate to be processed. Therefore, conventionally, a region between the imprint resist patterns is not covered with the imprint resist. Hereinafter, a gap region will be referred to a region between the imprint resist patterns.

The width of the gap region is about several tens of micrometers (for example, 30 μm). In general, an element pattern is not formed in the gap region, but a dicing line and a base pattern are formed in the gap region. Examples of the base pattern include alignment marks used in the alignment process and various kinds of monitor patterns. The monitor patterns include, for example, a monitor pattern for measuring dimensions and a monitor pattern for measuring the accuracy of an overlay used to manufacture a semiconductor device with a multi-layer structure.

As described above, the gap region is not covered with the imprint resist. Therefore, when the substrate to be processed is etched, the base pattern is damaged by, for example, plasma. As a result, the subsequent alignment process is hindered by the damage of the base pattern, which results in a reduction in yield.

In addition, the following problems arise. That is, when a semiconductor device with a multi-layer structure is manufactured, a portion of the substrate to be processed in the gap region is etched whenever the imprint method is performed, and deep grooves are formed in the gap region. When the grooves are formed, it is difficult to uniformly apply a resist onto the substrate to be processed. Therefore, it is difficult to use the spin coating method. As a result, for example, it is difficult to form an interlayer insulating film.

### SUMMARY OF THE INVENTION

According to a first aspect of the invention, there is provided a template used in an optical imprint method. The template includes: a substrate; a pattern forming region that is provided on the substrate and includes an imprint pattern; a first step portion that is provided outside the pattern forming region and is disposed below the pattern forming region; a first side portion that connects the pattern forming region and the first step portion; a second step portion that is provided outside the first step portion and is disposed below the first step portion; and a second side portion that connects the first step portion and the second step portion and has a surface roughness more than that of the first side portion.

According to a second aspect of the invention, there is provided a method of manufacturing a template used in an optical imprint method. The method includes: forming a first resist film in a pattern forming region that is provided on a substrate and has an imprint pattern formed therein; performing anisotropic etching using the first resist film as a mask to remove the substrate to a predetermined depth, thereby forming a first step portion and a first side portion that connects the pattern forming region and the first step portion; forming a second resist film in the pattern forming region and an outer circumferential portion surrounding the pattern forming region; and performing wet etching using the second resist film as a mask to remove the substrate to a predetermined depth, thereby forming a second step portion and a second side portion that connects the first step portion and the second step portion.

According to a third aspect of the invention, there is provided a method of manufacturing a template used in an optical imprint method. The method includes: forming a first resist film in a pattern forming region that is provided on a substrate and has an imprint pattern formed therein and an outer circumferential portion surrounding the pattern forming region; performing wet etching using the first resist film as a mask to remove the substrate to a predetermined depth; forming a second resist film in the pattern forming region; and performing anisotropic etching using the second resist film as a mask to remove the substrate to a predetermined depth, thereby forming a first step portion and a first side portion that connects the pattern forming region and the first step portion.

### BRIEF DESCRIPTION OF THE DRAWINGS

FIG. 1A is a cross-sectional view illustrating a process of manufacturing a template according to a first embodiment of the invention;

FIG. 1B is a cross-sectional view illustrating a process of manufacturing the template according to the first embodiment subsequent to FIG. 1A;

FIG. 1C is a cross-sectional view illustrating a process of manufacturing the template according to the first embodiment subsequent to FIG. 1B;

FIG. 1D is a cross-sectional view illustrating a process of manufacturing the template according to the first embodiment subsequent to FIG. 1C;

FIG. 1E is a cross-sectional view illustrating a process of manufacturing the template according to the first embodiment subsequent to FIG. 1D;

FIG. 1F is a cross-sectional view illustrating a process of manufacturing the template according to the first embodiment subsequent to FIG. 1E;

FIG. 2 is a bottom view illustrating the template according to the first embodiment;

FIG. 3A is a cross-sectional view illustrating a modification of the process of manufacturing the template according to the first embodiment;

FIG. 3B is a cross-sectional view illustrating the modification of the process of manufacturing the template according to the first embodiment subsequent to FIG. 3A;

FIG. 3C is a cross-sectional view illustrating the modification of the process of manufacturing the template according to the first embodiment subsequent to FIG. 3B;

FIG. 3D is a cross-sectional view illustrating the modification of the process of manufacturing the template according to the first embodiment subsequent to FIG. 3C;

FIG. 3E is a cross-sectional view illustrating the modification of the process of manufacturing the template according to the first embodiment subsequent to FIG. 3D;

FIG. 3F is a cross-sectional view illustrating the modification of the process of manufacturing the template according to the first embodiment subsequent to FIG. 3E;

FIG. 4A is a diagram illustrating an optical imprint method using the template according to the first embodiment;

FIG. 4B is a diagram illustrating the optical imprint method using the template according to the first embodiment subsequent to FIG. 4A;

FIG. 4C is a diagram illustrating the optical imprint method using the template according to the first embodiment subsequent to FIG. 4B;

FIG. 4D is a diagram illustrating the optical imprint method using the template according to the first embodiment subsequent to FIG. 4C;

FIG. 4E is a diagram illustrating the optical imprint method using the template according to the first embodiment subsequent to FIG. 4D;

FIG. 4F is a diagram illustrating an imprint resist pattern formed using the template according to the first embodiment;

FIG. 5 is a cross-sectional view illustrating a modification of the template according to the first embodiment;

FIG. 6 is a bottom view illustrating another modification of the template according to the first embodiment;

FIG. 7 is a cross-sectional view illustrating a template according to a second embodiment of the invention;

FIG. 8A is a cross-sectional view illustrating an optical imprint method using the template according to the second embodiment;

FIG. 8B is a cross-sectional view illustrating the optical imprint method using the template according to the second embodiment subsequent to FIG. 8A;

FIG. 9A is a cross-sectional view illustrating a process of manufacturing a template according to a comparative example;

FIG. 9B is a cross-sectional view illustrating a process of manufacturing the template according to the comparative example subsequent to FIG. 9A;

FIG. 9C is a cross-sectional view illustrating a process of manufacturing the template according to the comparative example subsequent to FIG. 9B;

FIG. 9D is a cross-sectional view illustrating a process of manufacturing the template according to the comparative example subsequent to FIG. 9C;

FIG. 10 is a bottom view illustrating the template according to the comparative example; and

FIG. 11 is a diagram illustrating an imprint resist pattern formed using the template according to the comparative example.

### DESCRIPTION OF THE EMBODIMENTS

Before exemplary embodiments of the invention are described, the way the inventors conceived the invention will be described.

As described above, in the known imprint method, the imprint resist is not applied to the gap region. Therefore, when a substrate to be processed is etched, the base pattern of the gap region is damaged or grooves are formed in the gap region.

Therefore, first, the inventors considered a method of covering the gap region with an imprint resist using the protrusion of the imprint resist during a pressing process, as a modification of the method of applying the imprint resist.

That is, the amount of imprint resist applied during an application process is increased and alignment is performed such that the width of the gap region is about several tens of nanometers during an alignment process.

When the application amount of imprint resist is increased, the imprint resist protrudes from a region in which the imprint resist pattern is essentially formed on the substrate to be processed to the gap region between the imprint resist pattern forming regions. Hereinafter, an imprint resist pattern forming region will be referred to a region in which the imprint resist pattern is essentially formed on the substrate to be processed. The protruding imprint resist comes into contact with the end of an adjacent imprint resist pattern and covers the gap region by surface tension in a self-aligned manner. For example, the amount of protrusion of the imprint resist is set such that the imprint resist protrudes from the imprint resist pattern forming region by about half of the width of the gap region. In this way, it is possible to cover the gap region.

However, the inventors found that the above-mentioned method had the following problems. In the known template, the roughness of the edge of the pattern forming region is about several micrometers, which will be described below. The term “pattern forming region” herein means a region for forming an imprint pattern in the region of the substrate of the template.

Therefore, the line edge roughness (LER) of the imprint resist pattern formed using the known template is significantly more than the width of the gap region, which is several tens of nanometers, in consideration of the size of the roughness of the edge of the pattern forming region. The term “line edge roughness” herein means fluctuation from the straight line of the edge of the imprint resist pattern (the degree of unevenness). As a result, in the method using the known template, it is difficult to uniformly cover the gap region with the imprint resist, without any gap.

The above-mentioned problems will be described in detail.

First, a method of manufacturing the known template, which is a comparative example, will be described and then the reason why the roughness of the edge of the pattern forming region is increased will be described.

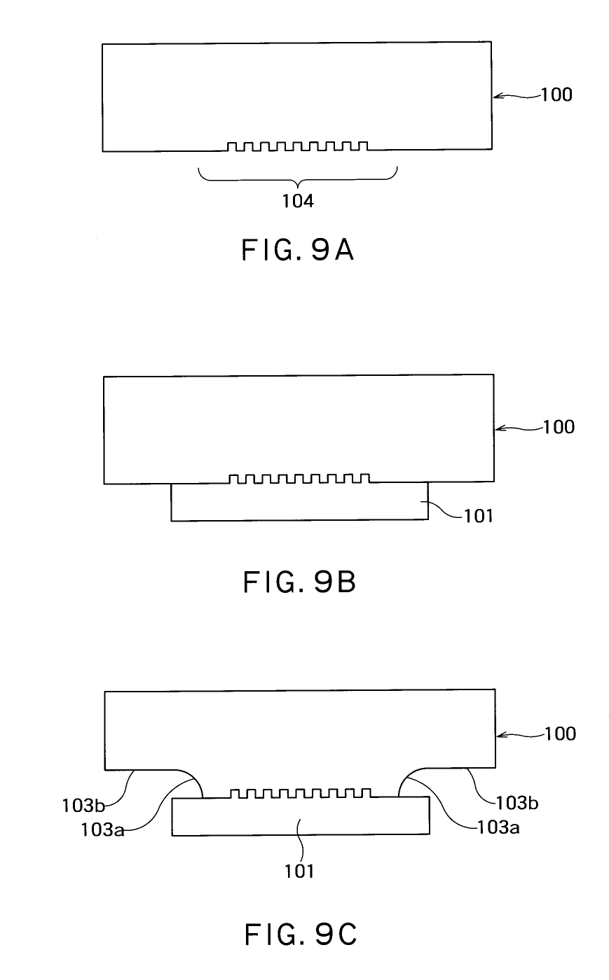

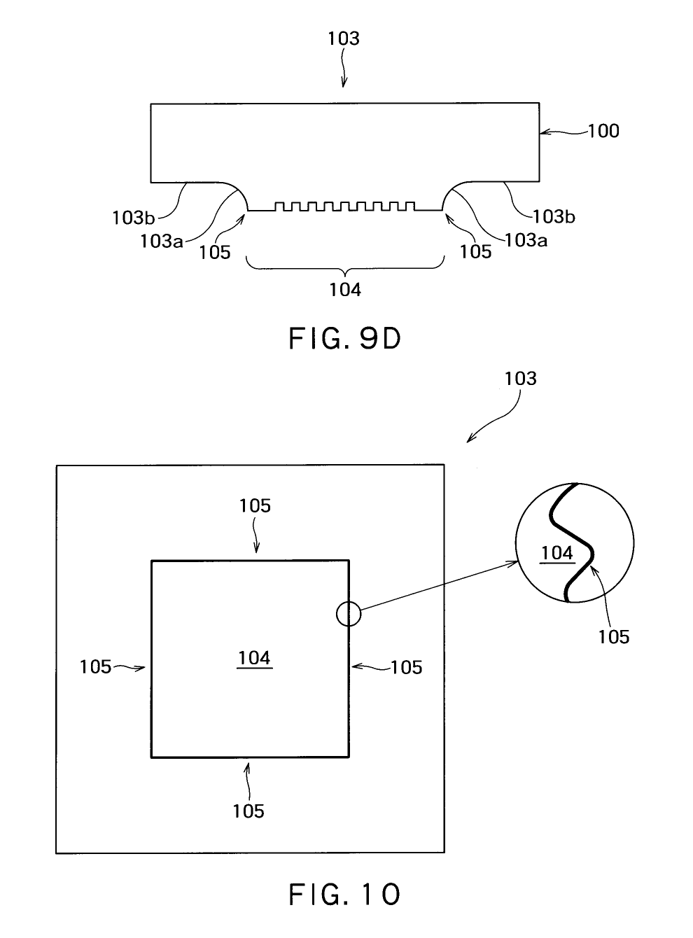

A method of manufacturing a template according to a comparative example will be described with reference to FIGS. 9A to 9D, which are cross-sectional views illustrating a process of the method.

(1) First, as can be seen from FIG. 9A, an imprint pattern is formed in a predetermined region (pattern forming region 104) on the surface of a substrate 100 made of quartz. The depth of grooves in the imprint pattern is in the range of, for example, 60 nm to 70 nm. The pattern forming region 104 has a size of, for example, 33 mm×26 mm.

(2) Then, as can be seen from FIG. 9B, a resist film 101 is formed in the pattern forming region 104 by photolithography.

(3) Then, as can be seen from FIG. 9C, wet etching with a high etching speed is performed on the substrate 100 using the resist film 101 as a mask to remove the substrate 100 to a predetermined depth. As shown in FIG. 9C, a side portion 103a and a step portion 103b are formed by the wet etching. The side portion 103a connects the step portion 103b and the pattern forming region 104. As can be seen from FIG. 9C, the side portion 103a is curved since it is formed by side etching the substrate 100.

The depth of etching is determined such that the template does not interfere with the substrate to be processed (wafer) in the pressing process. For example, the substrate 100 is etched to a depth of about 15 μm to 30 μm.

(4) Then, the resist film 101 is removed.

A template 103 shown in FIG. 9D according to the comparative example is obtained by the above-mentioned process. FIG. 10 is a bottom view illustrating the template 103. As can be seen from FIG. 10, in an enlarged view of the edge 105 of the pattern forming region 104, a roughness of about several micrometers is viewed. The roughness is formed when wet etching is performed on the substrate 100.

Next, an optical imprint method using the template 103 according to the comparative example will be described. In the optical imprint method using the template 103, the application amount of imprint resist is increased in an application process, and alignment is performed such that the width of the gap region is about several tens of nanometers in an alignment process.

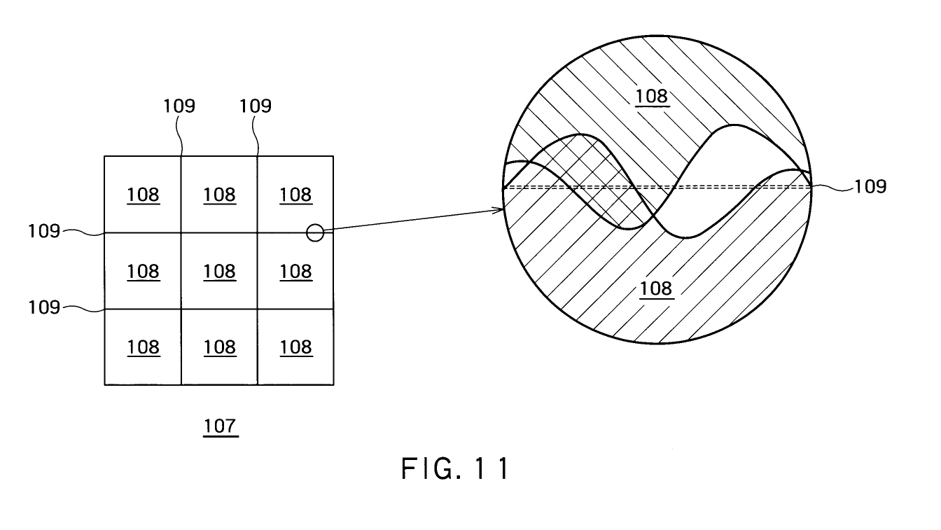

FIG. 11 shows imprint resist patterns 108, 108, . . . that are formed on a substrate 107 to be processed.

The line edge roughness of the imprint resist pattern 108 is about several micrometers, which is significantly larger than the width of the gap region 109, in consideration of the roughness of the edge 105 of the template 103. Therefore, as can be seen from the enlarged view of the gap region 109 shown in FIG. 11, there is a region that is doubly covered with the upper imprint resist pattern 108 shown in FIG. 11 and the lower imprint resist pattern 108 shown in FIG. 11 or a region that is not covered with any imprint resist pattern in the gap region 109.

As described above, when the template 103 according to the comparative example is used, it is difficult to uniformly cover the gap region 109 even though the application amount of imprint resist is changed such that the imprint resist protrudes. This is because the roughness of the edge 105 is more than the width of the gap region 109. Therefore, the problem of the gap region 109 being etched is not solved. When there is a region doubly covered with the imprint resist patterns in the gap region 109, there is a concern that the imprint resist will remain after a process (ashing) of removing the imprint resist pattern is performed. When ashing is performed for a long time in order to completely remove the imprint resist, the imprint resist pattern is likely to be damaged by oxygen plasma.

When the template 103 according to the comparative example is used, a portion of the imprint resist protruding from the pattern forming region 104 remains at the edge 105 of the template 103. Therefore, when imprinting is repeatedly performed, it is difficult to control the amount of protrusion of the imprint resist.

The invention has been made based on the technical recognition of the inventors described above. The invention provides a template in which a gap region of a substrate to be processed can be covered with an imprint resist, a method of manufacturing the same, and a method of forming a pattern according to the following exemplary embodiments.

Hereinafter, two embodiments of the invention will be described with reference to the drawings. A first embodiment relates to a method of manufacturing a template in which the roughness of the edge of a pattern forming region is significantly reduced. A second embodiment relates to a method of manufacturing a template in which a photocatalytic film is formed in a pattern forming region.

In the first and second embodiments, components having the same functions are denoted by the same reference numerals and a detailed description thereof will be omitted. In the drawings, the scale of each component is adjusted in order to have a recognizable size.

### First Embodiment

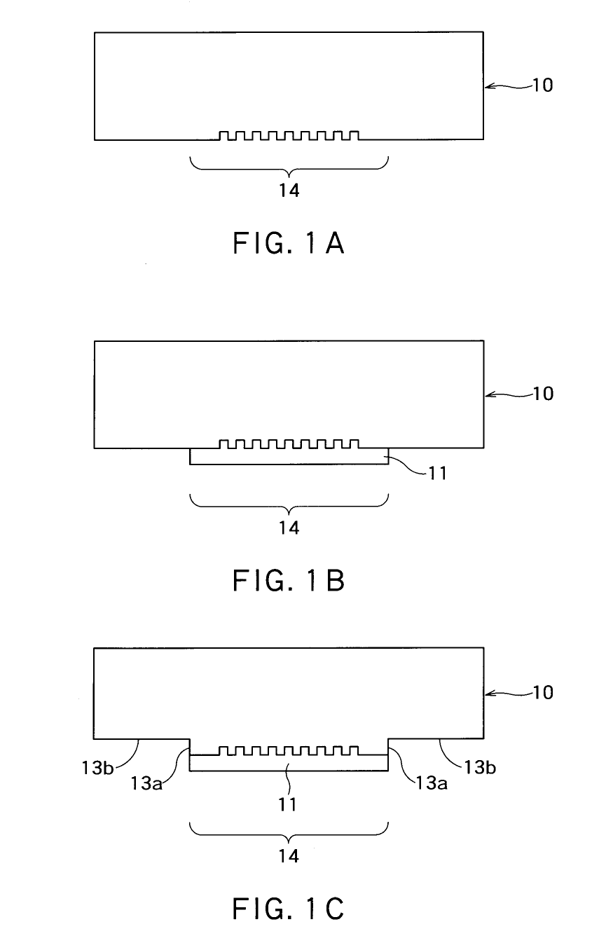

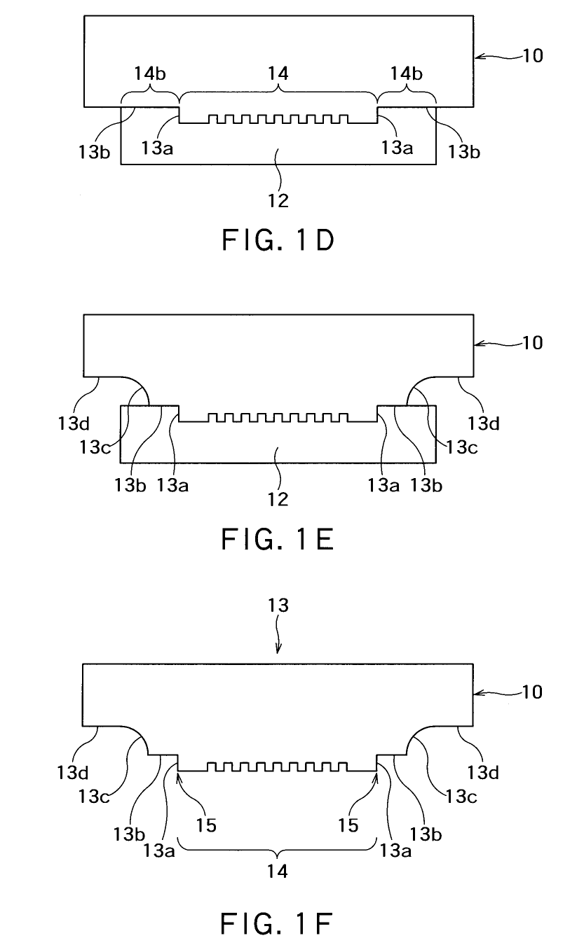

A method of manufacturing a template according to the first embodiment will be described with reference to FIGS. 1A to 1F. FIGS. 1A to 1F are cross-sectional views illustrating a process of manufacturing a template according to this embodiment.

(1) First, as can be seen from FIG. 1A, an imprint pattern is formed in a predetermined region (pattern forming region 14) on the surface of a substrate 10 that is transparent with respect to exposure light. The imprint pattern is formed by, for example, an imprint method, electron beam (EB) exposure, or reactive ion etching (RIE). The depth of grooves in the imprint pattern is in the range of, for example, 60 nm to 70 nm. The substrate 10 is made of, for example, quartz.

(2) Then, as can be seen from FIG. 1B, a resist film 11 is formed in the pattern forming region 14. The line edge roughness of the resist film 11 is equal to or less than the width of a gap region 19, which will be described below. The resist film 11 may be formed by electron beam exposure or EUV exposure as well as photolithography.

(3) Then, as can be seen from FIG. 1C, anisotropic etching (for example, RIE) is performed using the resist film 11 as a mask to remove the substrate 10 to a predetermined depth. As shown in FIG. 1C, a first side portion 13a and a first step portion 13b are formed by the etching. The first side portion 13a connects the first step portion 13b and the pattern forming region 14 and is substantially vertical to the surface of the pattern forming region 14.

The depth of etching is determined such that the imprint resist protruding from the pattern forming region 14 is not adhered to the first step portion 13b in a pressing process. For example, the depth of etching is 5 μm and preferably equal to or more than 1 μm.

(4) Then, as can be seen from FIG. 1D, after the resist film 11 is removed, a resist film 12 is formed in the pattern forming region 14 and an outer circumferential portion 14b (a portion of the first step portion 13b) of the pattern forming region 14 by for example, photolithography. The area of the outer circumferential portion 14b covered with the resist film 12 depends on wet etching conditions, which will be described below.

(5) Then, as can be seen from FIG. 1E, wet etching is performed using the resist film 12 as a mask to remove the substrate 10 to a predetermined depth. As shown in FIG. 1E, a second side portion 13c and a second step portion 13d are formed by the etching. The second side portion 13c connects the second step portion 13d and the first step portion 13b. Since the second side portion 13c is formed by wet etching, the roughness of the surface of the second side portion 13c is more than that of the first side portion 13a. As shown in FIG. 1E, the second side portion 13c is curved since it is formed by side etching the substrate 10.

The depth of etching is determined such that the template does not interfere with the substrate to be processed (wafer) in the pressing process. Etching is performed until the sum of the depth of etching by the above-mentioned anisotropic etching process and the depth of etching by the wet etching process is in the range of, for example, 15 μm to 30 μm. That is, when the substrate 10 is etched by 5 μm by the above-mentioned anisotropic etching process, the substrate 10 is etched by 10 μm to 25 μm by the wet etching process.

(6) Then, the resist film 12 is removed.

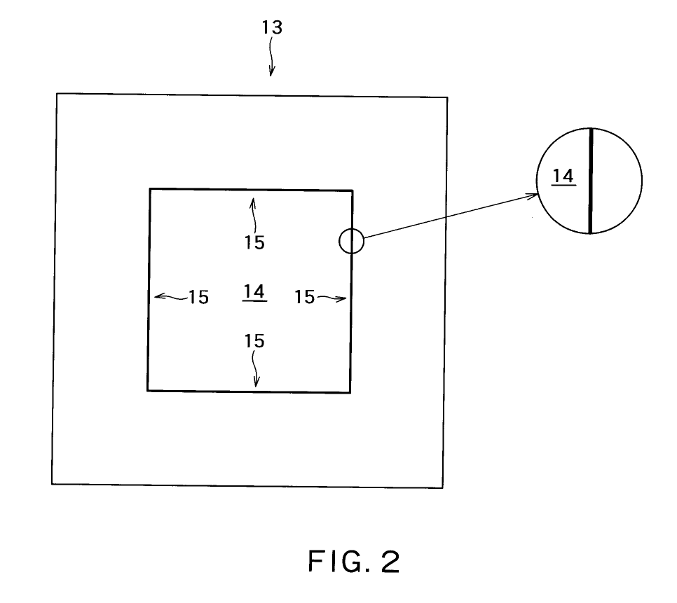

The template 13 according to this embodiment shown in FIG. 1F is obtained by the above-mentioned process. FIG. 2 is a bottom view illustrating the template 13. As described above, the first side portion 13a is formed by anisotropic etching using the resist film 11 with a very small line edge roughness as a mask. Therefore, as can be seen from the enlarged view of the edge 15 in FIG. 2, the roughness of the edge 15 of the pattern forming region 14 is very small and is equal to or less than the width of the gap region 19.

In the method of manufacturing the template according to this embodiment, it is possible to reduce the time required to manufacture the template by a combination of wet etching with large roughness and a high etching speed and anisotropic etching with small roughness and a low etching speed.

The imprint pattern may be formed after anisotropic etching is performed using the resist film 11 as a mask to remove the resist film 11 or after wet etching is performed using the resist film 12 as a mask to remove the resist film 12.

The template may be manufactured only by the anisotropic etching. In this case, in a process of etching the substrate 10 using the resist film 11 as a mask, anisotropic etching is performed until a desired depth (for example, 15 μm to 30 μm) is obtained. However, when RIE is used as the anisotropic etching, it takes a long time to etch the substrate, as compared to wet etching. Therefore, it takes a long time to manufacture a template.

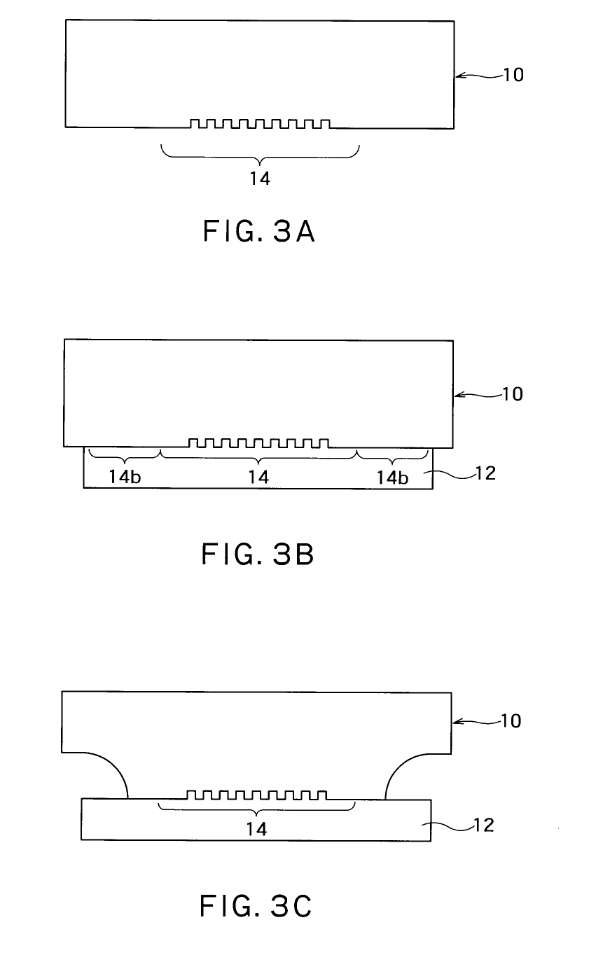

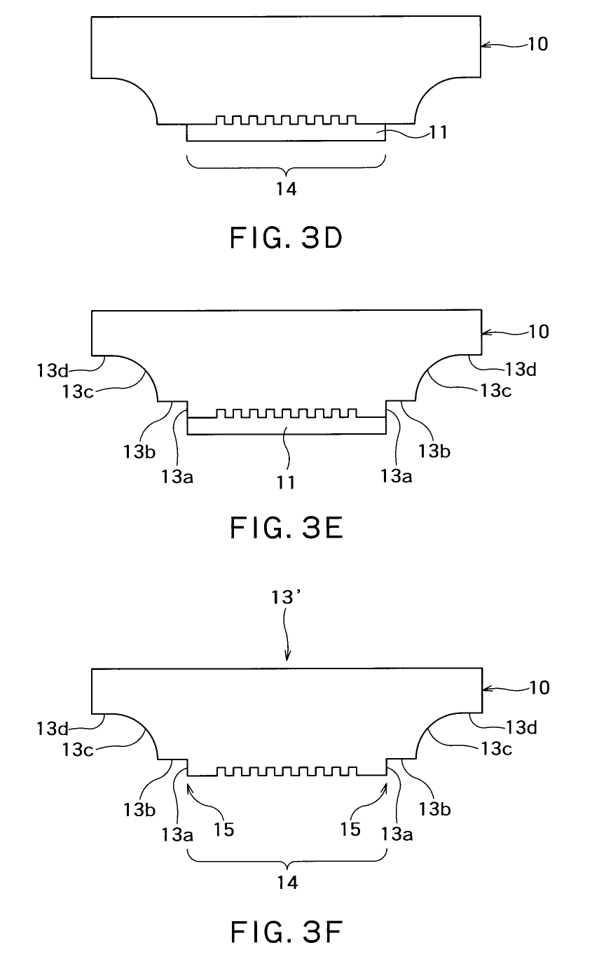

In this embodiment, anisotropic etching and wet etching are performed on the substrate 10 in this order. However, wet etching and anisotropic etching may be performed in this order to manufacture a template. The manufacturing method will be described with reference to FIGS. 3A to 3F.

(1) First, as can be seen from FIG. 3A, an imprint pattern is formed in the pattern forming region 14 of the substrate 10.

(2) Then, as can be seen from FIG. 3B, the resist film 12 is formed in the pattern forming region 14 and the outer circumferential portion 14b surrounding the pattern forming region 14 by, for example, photolithography.

(3) Then, as can be seen from FIG. 3C, wet etching is performed using the resist film 12 as a mask to remove the substrate 10 to a predetermined depth.

(4) Then, as can be seen from FIG. 3D, after the resist film 12 is removed, the resist film 11 is formed in the pattern forming region 14.

(5) Then, as can be seen from FIG. 3E, anisotropic etching (for example, RIE) is performed using the resist film 11 as a mask to remove the substrate 10 to a predetermined depth. As shown in FIG. 3E, the first side portion 13a, the first step portion 13b, the second side portion 13c, and the second step portion 13d are formed by the etching.

(6) Then, the resist film 11 is removed.

In this way, a template 13′ according to this embodiment shown in FIG. 3F is obtained.

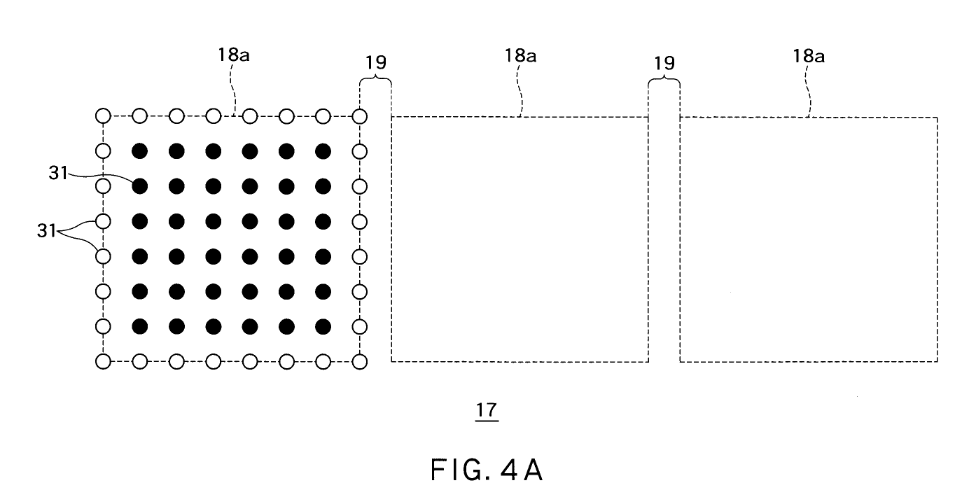

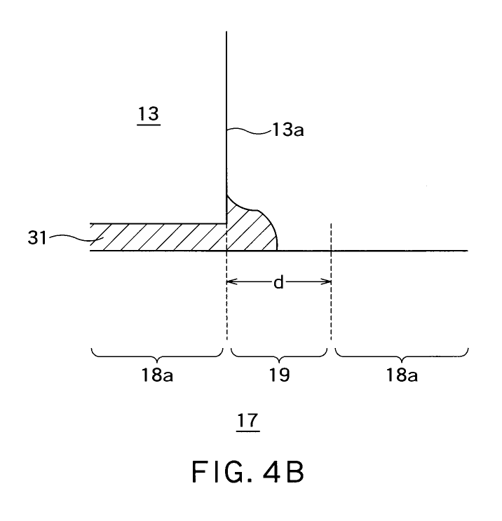

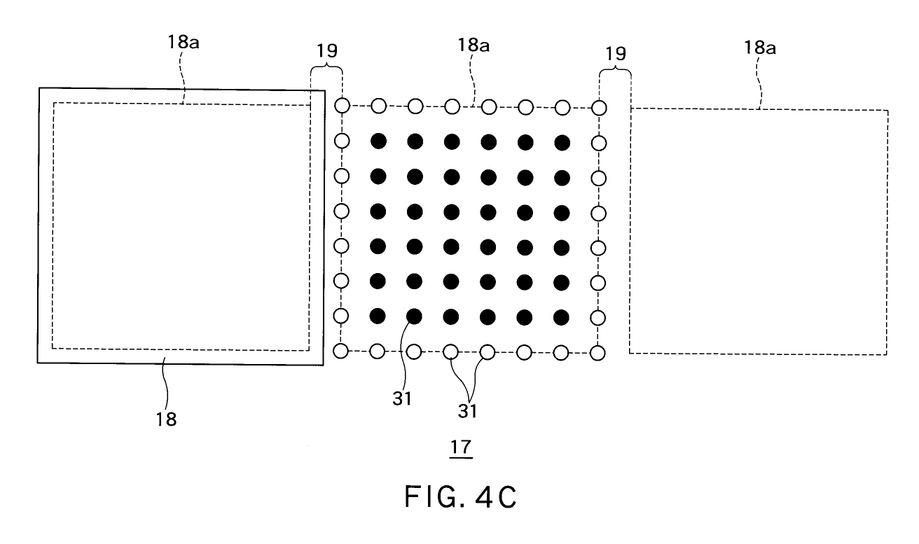

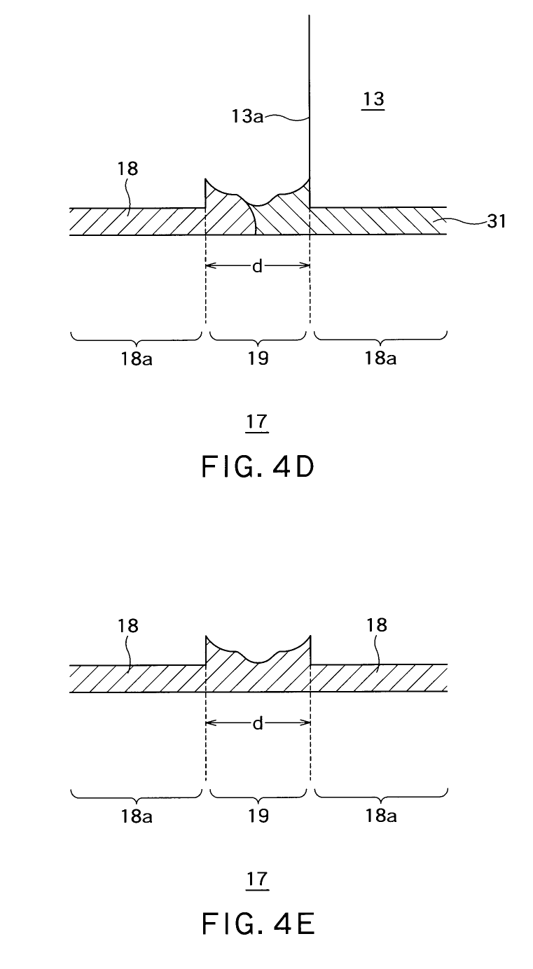

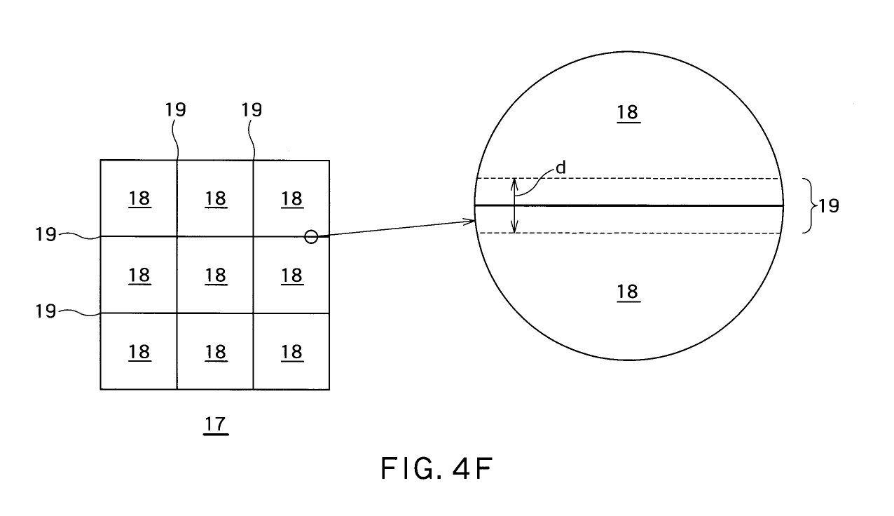

Next, an optical imprint method using the template 13 (13′) according to this embodiment will be described with reference to FIGS. 4A to 4F. FIGS. 4A and 4C are plan views illustrating a photo-curable resist 31 applied to an imprint resist pattern forming region 18a of a substrate 17 to be processed. FIGS. 4B and 4D are cross-sectional views illustrating the substrate 17 to be processed and the template 13 in the pressing process. FIG. 4E is a cross-sectional view illustrating the substrate 17 to be processed and an imprint resist pattern 18 after a demolding process. FIG. 4F is a top view illustrating a plurality of imprint resist patterns 18 formed on the substrate 17 to be processed.

(1) First, a photo-curable resist 31 is applied as liquid droplets to the imprint resist pattern forming regions 18a of the substrate 17 to be processed. Specifically, liquid droplets are applied to the imprint resist pattern forming regions 18a (see black circles in FIG. 4A). In addition, liquid droplets are applied in the vicinity of the boundary between the imprint resist pattern forming regions 18a (see white circles in FIG. 4A).

(2) Then, the substrate 17 to be processed and the template 13 are aligned with each other. The alignment is performed using alignment marks (not shown) on the substrate 17 to be processed. The alignment is performed such that the pattern forming region 14 of the template 13 is disposed immediately above the imprint resist pattern forming region 18a.

(3) Then, the template 13 comes into contact with the photo-curable resist 31 on the substrate 17 to be processed. The distance between the template 13 and the substrate 17 to be processed is maintained at, for example, 15 nm. In this process, the photo-curable resists 31, 31, . . . which are liquid droplets, are integrated into a photo-curable resist film, and the integrated photo-curable resist 31 protrudes from the pattern forming region 14 along an uneven (LER) portion of the edge 15 of the template 13.

In this way, as shown in FIG. 4B, the integrated photo-curable resist 31 protrudes from the imprint resist pattern forming region 18a and covers a portion of the gap region 19.

(4) Then, a transfer process of radiating UV light to cure the photo-curable resist 31 and a demolding process of separating the template 13 from the cured photo-curable resist 31 are performed to form the imprint resist pattern 18.

As can be seen from FIG. 4C, the imprint resist pattern 18 formed on the left side of FIG. 4C protrudes from the imprint resist pattern forming region 18a and covers half of the gap region 19.

(5) Then, as can be seen from FIG. 4C, similar to the above-mentioned process, the photo-curable resist 31 is applied to the imprint resist pattern forming region 18a that is disposed at the center of FIG. 4C. The distance between the imprint resist pattern forming regions 18a, that is, the width of the gap region is about several tens of nanometers.

(6) Then, similar to the above-mentioned process, the substrate 17 to be processed and the template 13 are aligned with each other.

(7) Then, similar to the above-mentioned process, the template 13 comes into contact with the photo-curable resist 31 applied onto the substrate 17 to be processed.

In this way, as shown in FIG. 4D, the photo-curable resist 31 protrudes from the imprint resist pattern forming region 18a and comes into contact with an adjacent imprint resist pattern 18 by surface tension in a self-aligned manner. As a result, the gap region 19 is completely covered with the imprint resist patterns 18, 18 (imprint resist).

(8) Then, the transfer process and the demolding process are performed to form the imprint resist pattern 18. FIG. 4E is a cross-sectional view illustrating the imprint resist patterns 18, 18 in the vicinity of the gap region 19 after the demolding process. As can be seen from FIG. 4E, the gap region 19 is completely covered with the imprint resist patterns 18, 18 (imprint resist).

FIG. 4F is a top view illustrating a plurality of imprint resist patterns 18, 18, . . . formed on the substrate 17 to be processed. As shown in FIG. 4F, the imprint resist patterns 18, 18, . . . are regularly arranged so as to be adjacent to each other without any gap therebetween.

As can be seen from the enlarged view around the boundary of the imprint resist patterns shown in FIG. 4F, the upper and lower imprint resist patterns 18, 18 shown in FIG. 4F protrude by a distance that is substantially equal to half the width of the gap region and contact with each other. Accordingly, the gap region 19 (a region interposed between dashed lines in the enlarge view of FIG. 4F) is uniformly covered with the imprint resist patterns 18, 18 (imprint resist) without any gap.

The line edge roughness of the imprint resist pattern 18 is determined in consideration of the roughness of the edge 15 of the template 13 (13′). As described above, since the roughness of the edge 15 is formed to be equal to or less than the width of the gap region 19, it is possible to make the line edge roughness of the imprint resist pattern 18 equal to or less than the width of the gap region 19. Therefore, when the optical imprint method using the template according to this embodiment is performed, it is possible to uniformly cover the gap region 19 with the imprint resist without any gap, as shown in FIG. 4F.

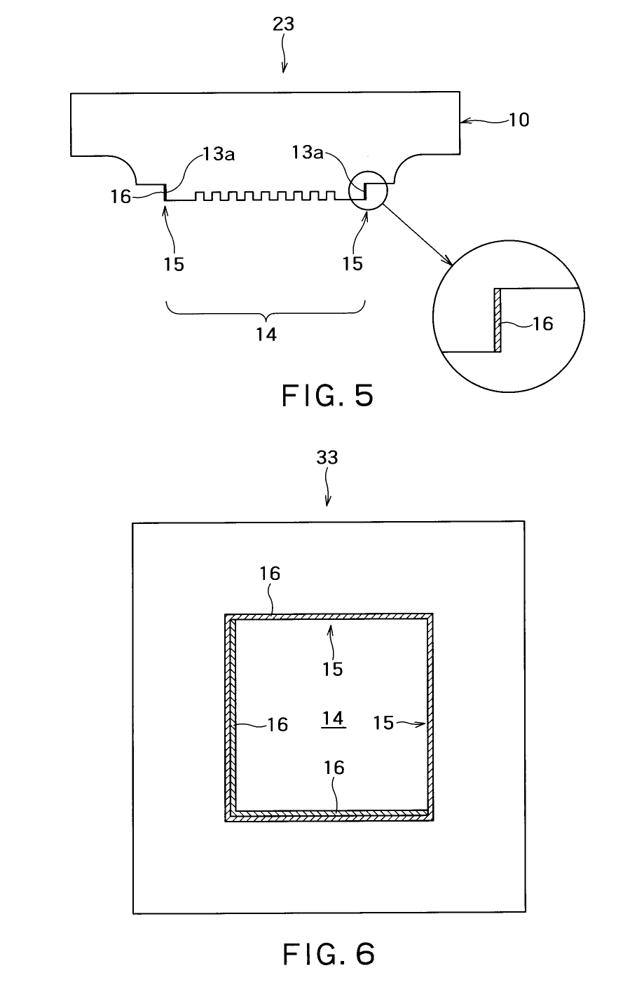

Next, a template 23 obtained by performing an antifouling process on the template 13 (13′), which is a modification of the template according to this embodiment, will be described with reference to FIG. 5. FIG. 5 is a cross-sectional view illustrating the template 23.

As can be seen from FIG. 5, the template 23 is obtained by performing an antifouling process on the first side portion 13a of the template 13 (13′). Specifically, a film 16 made of a water-repellant or oil-repellant material is formed on the first side portion 13a. The film 16 is made of a material with water repellency or oil repellency that is higher than that of a material forming the substrate 10. For example, the film 16 is made of a fluorine-based material, such as fluorocarbon, for the substrate 10 made of quartz.

For example, the antifouling process is performed after the template 13 (13′) is completed or after anisotropic etching is performed in the method of manufacturing the template according to this embodiment.

The antifouling process is not necessarily performed on the entire surface of the first side portion 13a, but it may be performed on a region of the first side portion 13a to which the protruding imprint resist is adhered during the pressing process.

In the imprint method using the template 23, since the antifouling process is performed on the first side portion 13a of the pattern forming region 14, the protruding imprint resist does not remain in the first side portion 13a. Therefore, even when imprinting (shot) is repeatedly performed, it is possible to accurately control the amount of protrusion of the imprint resist. As a result, it is possible to cover the gap region with the imprint resist with high reproducibility.

The antifouling process may be performed on at least one end of the pattern forming region 14. In this way, it is possible to control the protrusion of the imprint resist from the side of the pattern forming region 14 subjected to the antifouling process. This will be described with reference to an example of the template shown in FIG. 6. FIG. 6 is a bottom view illustrating a template 33. As can be seen from FIG. 6, in the template 33, the film 16 is formed on the left and lower sides of the pattern forming region 14. Accordingly, the imprint resist can protrude from only the right and upper sides of the pattern forming region 14.

In a method of applying the imprint resist in the application process, as shown in FIGS. 4A and 4C, the imprint resist may be applied in the vicinity of the boundary between four sides of the imprint resist pattern forming region 18a. Alternatively, a large amount of imprint resist may be applied in the vicinity of the boundary of the imprint resist pattern forming region 18a adjacent to the imprint resist pattern 18, and a general amount of imprint resist or a small amount of imprint resist may be applied in the vicinity of the boundary of the imprint resist pattern forming region 18a that is not adjacent to the imprint resist pattern 18. That is, according to an example in FIG. 4C, the photo-curable resist 31 may be applied into the imprint resist pattern forming region 18a disposed at the center of FIG. 4C and in the vicinity of the boundary of the left side of the imprint resist pattern forming region 18a.

As described above, according to this embodiment, a template in which the roughness of the edge of the pattern forming region is very small is obtained.

When an optical imprint method using the template is performed, it is possible to uniformly cover the gap region with the imprint resist. Accordingly, it is possible to prevent a base pattern formed in the gap region from being damaged or prevent grooves from being formed in the gap region. Therefore, it is possible to improve the accuracy of forming a pattern using the optical imprint method and thus improve the yield of semiconductor devices. In addition, it is possible to use a process using a spin coating method (for example, a process of forming an interlayer insulating film).

According to this embodiment, it is also possible to obtain a template in which the antifouling process is performed on the side of the pattern forming region. The antifouling process prevents the imprint resist from remaining on the side of the pattern forming region even when imprinting is repeatedly performed. Therefore, it is possible to accurately control the amount of protrusion of the imprint resist. Accordingly, it is possible to cover the gap region with the imprint resist with high reproducibility.

### Second Embodiment

Next, a second embodiment will be described. In this embodiment, a film (photocatalytic film) made of a photocatalytic material is formed in at least a peripheral portion (a portion in which the imprint pattern is not formed) of the pattern forming region of the template according to the first embodiment. In addition, an imprint resist including fluorine is used.

The optical imprint method according to the first embodiment is performed using the template and the imprint resist. In this way, a predetermined portion of the imprint resist pattern has water repellency or oil repellency. Even when the imprint resist protrudes excessively, it is possible to prevent adjacent imprint resists from overlapping each other.

Hereinafter, the second embodiment will be described in detail.

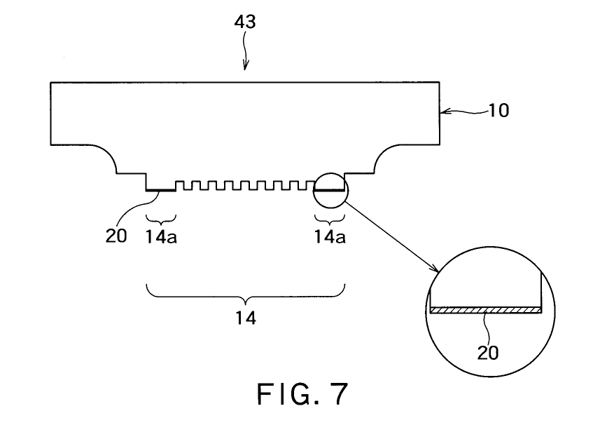

FIG. 7 is a cross-sectional view illustrating a template 43 according to the second embodiment. As can be seen from FIG. 7, a photocatalytic film 20 made of, for example, a titanium oxide (TiO₂) is formed in a peripheral portion 14a of the pattern forming region 14.

For example, the photocatalytic film 20 is formed in at least the peripheral portion 14a of the pattern forming region 14 after the imprint pattern is formed, after the template 13 (13′) is completed, or after the film 16 is formed in the method of manufacturing the template according to the first embodiment. The photocatalytic film 20 may be formed on the entire surface of the pattern forming region 14.

Next, an optical imprint method using the template 43 according to the second embodiment and an imprint resist including fluorine will be described.

(1) An application process is performed in the same way as that in the first embodiment. The fluorine containing imprint resist 21 which contains fluorine is used as the imprint resist.

(2) Then, an alignment process and a pressing process are performed in the same way as that in the first embodiment.

(3) Then, a transfer process of radiating UV light to cure a photo-curable resist is performed.

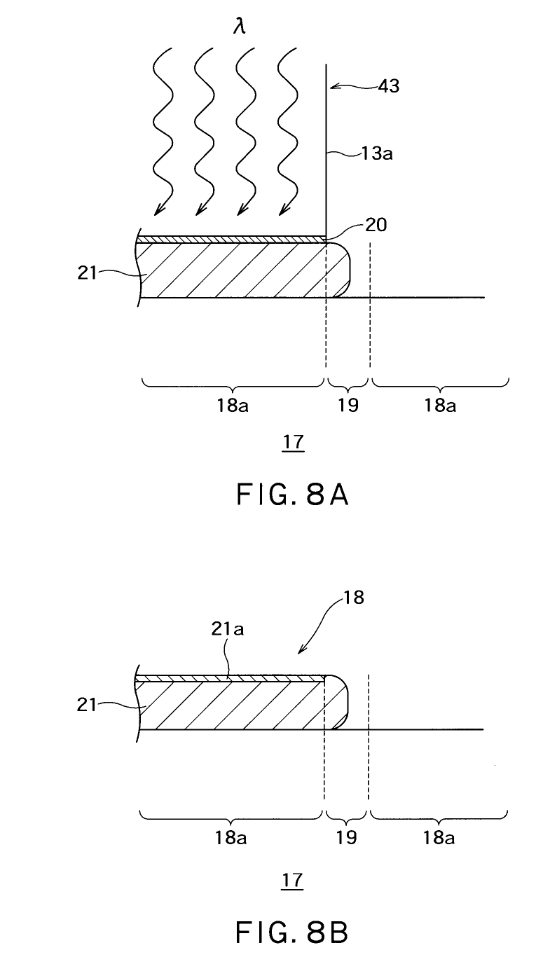

FIG. 8A is a cross-sectional view illustrating the substrate 17 to be processed, the fluorine containing imprint resist 21, and the template 43 in the transfer process.

As shown in FIG. 8A, when UV light (λ) is radiated from the upper side of FIG. 8A, the fluorine containing imprint resist 21 is cured. In addition, when the UV light is radiated, a fluorine containing composition in the fluorine containing imprint resist 21 is drawn to the interface between the photocatalytic film 20 and the fluorine containing imprint resist 21 and is then precipitated on the upper surface of the fluorine containing imprint resist 21. In this way, a fluorine film 21a including at least fluorine is formed.

(4) Then, a demolding process of separating the template 43 from the imprint resist pattern 18 is performed.

FIG. 8B is a cross-sectional view illustrating the substrate 17 to be processed and the imprint resist pattern 18 after the template 43 is separated. As can be seen from FIG. 8B, the water-repellant or oil-repellant fluorine film 21a is formed in a portion of the fluorine containing imprint resist 21 that comes into contact with the photocatalytic film 20. When another imprint resist pattern is formed in a region adjacent to the formed imprint resist pattern 18, the formed fluorine film 21a prevents the imprint resist from being laid on an adjacent imprint resist pattern 18 even though the imprint resist excessively protrudes in the pressing process.

As described above, according to this embodiment, a template in which a photocatalytic film is formed in at least a peripheral portion of the pattern forming region of the template according to the first embodiment is obtained.

When an optical imprint method is performed using the template according to this embodiment and a fluorine containing imprint resist, a water-repellant or oil-repellant fluorine film is formed in a portion of the upper surface of the imprint resist pattern that comes into contact with the photocatalytic film by the radiation of UV light. Accordingly, even when the imprint resist excessively protrudes in the pressing process, it is possible to prevent the protruding imprint resist from being laid on an adjacent imprint resist pattern.

Additional advantages and modifications will readily occur to those skilled in the art.

Therefore, the invention in its broader aspects is not limited to the specific details and representative embodiments shown and described herein.

Accordingly, various modifications may be made without departing from the spirit or scope of the general inventive concepts as defined by the appended claims and their equivalents.

What is claimed is:

1. A template used in an optical imprint method, comprising:
a substrate;
a pattern forming region that is provided on the substrate and includes an imprint pattern;
a first step portion that is provided outside the pattern forming region and is disposed below the pattern forming region;
a first side portion that connects the pattern forming region and the first step portion;
a second step portion that is provided outside the first step portion and is disposed below the first step portion; and
a second side portion that connects the first step portion and the second step portion and has a surface roughness more than that of the first side portion.

2. The template according to claim 1, further comprising:
a film that is made of a material with water repellency or oil repellency higher than that of a material forming the substrate and is provided in at least a portion of the first side portion.

3. The template according to claim 2, further comprising:
a film that is made of a material with water repellency or oil repellency higher than that of the material forming the substrate and is provided in at least one end of the pattern forming region.

4. The template according to claim 2, further comprising:
a photocatalytic film that is provided in at least a peripheral portion of the pattern forming region.

5. The template according to claim 4,
wherein the photocatalytic film is made of a titanium oxide (TiO₂).

6. The template according to claim 1, further comprising:
a photocatalytic film that is provided in at least a peripheral portion of the pattern forming region.

7. The template according to claim 6,
wherein the photocatalytic film is made of a titanium oxide (TiO₂).

8. A method of forming a pattern using the template according to claim 6, comprising:
applying an imprint resist including fluorine into an imprint resist pattern forming region of a substrate to be processed and in the vicinity of the boundary of the imprint resist pattern forming region;
aligning the substrate to be processed with the template such that the pattern forming region of the template is disposed immediately above the imprint resist pattern forming region;
contacting the template with the imprint resist such that the imprint resist protrudes from the imprint resist pattern forming region to a gap region; and
radiating UV light to the imprint resist to cure the imprint resist and to form a fluorine film including at least fluorine on an upper surface of the imprint resist which comes into contact with the photocatalytic film.

9. A method of forming a pattern using the template according to claim 1, comprising:
applying an imprint resist into an imprint resist pattern forming region of a substrate to be processed and in the vicinity of the boundary of the imprint resist pattern forming region;
aligning the substrate to be processed with the template such that the pattern forming region of the template is disposed immediately above the imprint resist pattern forming region;
contacting the template with the imprint resist such that the imprint resist protrudes from the imprint resist pattern forming region to a gap region; and
radiating UV light to the imprint resist to cure the imprint resist.

10. A method of manufacturing a template used in an optical imprint method, comprising:
forming a first resist film in a pattern forming region that is provided on a substrate and has an imprint pattern formed therein;
performing anisotropic etching using the first resist film as a mask to remove the substrate to a predetermined depth, thereby forming a first step portion and a first side portion that connects the pattern forming region and the first step portion;
forming a second resist film in the pattern forming region and an outer circumferential portion surrounding the pattern forming region; and
performing wet etching using the second resist film as a mask to remove the substrate to a predetermined depth, thereby forming a second step portion and a second side portion that connects the first step portion and the second step portion.

11. The method of manufacturing a template according to claim 10, further comprising:
forming a film made of a material with water repellency or oil repellency higher than that of a material forming the substrate in at least a portion of the first side portion.

12. The method of manufacturing a template according to claim 11, further comprising:
forming a film made of a material with water repellency or oil repellency higher than that of the material forming the substrate in at least one end of the pattern forming region.

13. The method of manufacturing a template according to claim 10, further comprising:
forming a photocatalytic film in at least a peripheral portion of the pattern forming region.

14. The method of manufacturing a template according to claim 13,
wherein the photocatalytic film is made of a titanium oxide (TiO₂).

15. The method of manufacturing a template according to claim 10,
wherein reactive ion etching (RIE) is used as the anisotropic etching.

16. A method of manufacturing a template used in an optical imprint method, comprising:
forming a first resist film in a pattern forming region that is provided on a substrate and has an imprint pattern formed therein and an outer circumferential portion surrounding the pattern forming region;
performing wet etching using the first resist film as a mask to remove the substrate to a predetermined depth;
forming a second resist film in the pattern forming region; and
performing anisotropic etching using the second resist film as a mask to remove the substrate to a predetermined depth, thereby forming a first step portion and a first side portion that connects the pattern forming region and the first step portion.

17. The method of manufacturing a template according to claim 16, further comprising:
forming a film made of a material with water repellency or oil repellency higher than that of a material forming the substrate in at least a portion of the first side portion.

18. The method of manufacturing a template according to claim 17, further comprising:
forming a film made of a material with water repellency or oil repellency higher than that of the material forming the substrate in at least one end of the pattern forming region.

19. The method of manufacturing a template according to claim 16, further comprising:
forming a photocatalytic film in at least a peripheral portion of the pattern forming region.

20. The method of manufacturing a template according to claim 16,
wherein reactive ion etching (RIE) is used as the anisotropic etching.
